(19) United States
(12) Patent Application Publication
(10) Pub. No.: US 2007/0060056 A1
(43) Pub. Date: Mar. 15, 2007

(54) Remote Access Method and Device

(76) Inventors: John E. Whitaker, Bainbridge Island, WA (US); Laurence E. Lycke, Seattle, WA (US)

Correspondence Address: WHITAKER LAW GROUP, 755 WINSLOW WAY EAST, SUITE 304, BAINBRIDGE ISLAND, WA, 98110, US

(21) Appl. No.: 11/459,924

(22) Filed: Jul. 25, 2006

Related U.S. Application Data
(60) Provisional application No. 60/702,495, filed on Jul. 25, 2005.

(51) Int. Cl. H04B 7/00

(52) U.S. Cl. 455/41.2

(57) ABSTRACT

A system and method enable remotely accessing a host, such as an automobile or the like, using short range wireless communication functionality integrated into a mobile device.

### CROSS REFERENCE TO RELATED APPLICATIONS

This application claims priority to co-pending U.S. Provisional Patent Application No. 60/702,495, filed Jul. 25, 2005, and entitled “Remote Access Method and Device.”

### BACKGROUND

The present invention is directed at remotely activating a locking mechanism, preferably using a short range wireless communications infrastructure.

Automobiles today commonly include functionality to allow an owner to remotely lock or unlock the automobile. Many cars come with a system including a remote access sensor installed on the car, and a corresponding transmitter, commonly implemented as a key fob, to activate the remote access sensor. When a user is in range and presses a button on the key fob, the remote access sensor unlocks the doors of the car. This system is also commonly used to remotely open the trunk of the car.

One problem with existing systems is that the key fob is typically bulky. Many people disfavor a large key fob because it can create an unsightly bulge in the pocket, if the keys are kept in the pocket. Although many women typically carry their keys in their purses, in American society men don't generally carry purses and so must keep their keys in either their pants pocket or their jacket pocket. In addition, some women don't like to carry purses for various reasons and also don't like to have unsightly bulges in their pockets.

Another problem with existing systems is the inadequate functionality included in the key fob. In other words, generally such systems enable a user to lock and unlock the doors of the automobile, and perhaps open the trunk. Very little additional functionality, if any, is available. This is largely due to the fact that additional functionality requires more sophisticated circuitry, which in turn consumes more power. More power consumption means shorter battery life, and users generally disfavor having to frequently replace batteries in a key fob used mainly to activate their door locks.

A superior automotive access mechanism has eluded those skilled in the art, until now.

### SUMMARY OF THE INVENTION

The present invention is directed at a remote access system for an automobile. Briefly stated, the invention enables remote access to an automobile using wireless transmission capability incorporated in a wireless mobile device, such as a cellular telephone.

In one aspect, the invention envisions a wireless mobile device configured to facilitate wireless telephone communication, such as a cellular telephone, and that additionally includes short range wireless functionality, such as a personal area network transceiver. The mobile device includes operative functionality to transmit instructions using the short range wireless functionality to cause an automobile to perform certain access and/or configuration operations, such as unlocking the doors.

In another aspect, the invention envisions an automobile including a remote access controller operative to communicate using short range wireless functionality, such as a personal area network. The controller is configured to respond to commands received using the short range wireless functionality to perform operations on components of the automobile, such as locking and unlocking the doors, opening the trunk, opening and closing the windows, modifying the mirror configuration, activating and tuning the radio, operating the horn, and the like.

### BRIEF DESCRIPTION OF THE DRAWINGS

FIG. 1 is a functional block diagram of a system that includes a mobile device and a remote access controller installed in an automobile.

FIG. 2 is a functional block diagram generally illustrating in greater detail the mobile device depicted in FIG. 1.

FIG. 3 is a graphical illustration of a sample mobile device in which embodiments of the invention may be implemented.

FIG. 4 is a functional block diagram generally illustrating in greater detail the automobile depicted in FIG. 1.

FIG. 5 is an operational flow diagram generally illustrating steps performed by a process for remotely activating access functionality of an automobile.

FIG. 6 is an operational flow diagram generally illustrating steps performed by a process for performing access operations under remote control.

### DETAILED DESCRIPTION OF EMBODIMENTS

Briefly stated, the following detailed description is directed at a system and method for remotely accessing an automobile using short range wireless communication functionality integrated into a mobile device.

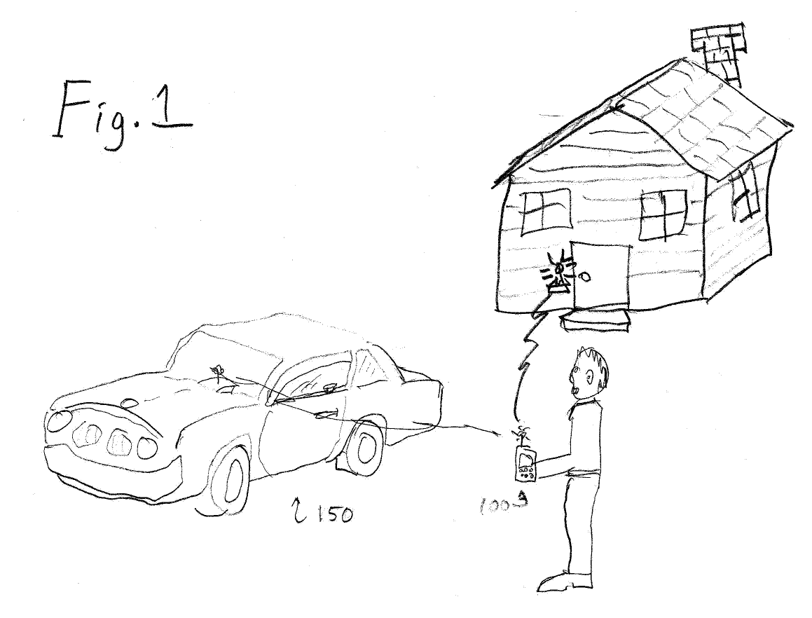

FIG. 1 is a functional block diagram of a system that includes a mobile device and a remote access controller installed in an automobile. In this implementation, the mobile device is a cellular telephone that includes cellular telephone communications capability. In addition, the mobile device also includes short range wireless communications capability. The mobile device is configured to transmit remote access instructions to the automobile. These remote access instructions are operative to cause the automobile to perform many different access operations, such as locking and unlocking the doors, rolling up or down the windows, opening the trunk, and the like.

The remote access controller is configured to communicate using the same short range wireless communications infrastructure as the mobile device. The remote access controller is configured to perform (or cause to be performed) at least one but preferably several remote access operations. For example, the remote access controller may be coupled to a lock actuator, an electric window actuator, a trunk actuator, and the like.

In operation, the user is in possession of the mobile device, and initiates a remote access program on the mobile device. By manipulating the remote access program, the user causes the mobile device to transmit, over the short range wireless communications infrastructure, a remote access instruction to the remote access controller in the automobile. The remote access instruction could include, for example, an instruction to lock or unlock the automobile's doors, to roll up or down the automobile's windows, or to open the trunk. Details of one particular embodiment of the invention which implements the general system just described are provided below.

Although described in the context of remote access to an automobile, implementations of the invention can be easily adapted to function in a home as well. For example, the remote access controller may be embedded in or proximate to a door (e.g., a front door or garage door) of a home. The remote access controller may then be configured to perform remote access operations on the door, such as unlocking the home's front door, opening the garage door, or the like. Accordingly, throughout this document, reference to an automobile should be considered as having equal applicability to an implementation in the home where a remote locking and unlocking mechanism may be implemented.

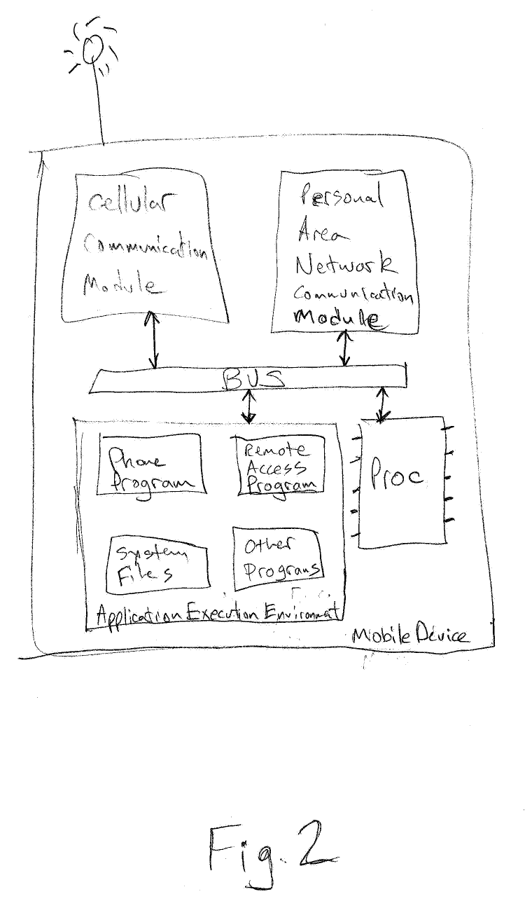

FIG. 2 is a functional block diagram generally illustrating in greater detail the mobile device depicted in FIG. 1 and described above. In this embodiment, the mobile device includes a cellular communication module for facilitating ordinary cellular telephone communications. The cellular communication module is configured to communicate with a cellular tower. In addition, the mobile device includes a personal area network communication module that implements a short range wireless communications infrastructure.

In one specific example, the personal area network communication module may implement the Bluetooth communications standard. The Term Bluetooth is a registered trademark of Bluetooth Sig, Inc, a Delaware Corporation. In this particular implementation, the personal area network communication module is configured to transmit and receive in the 2.45 GHz frequency band, which is used by both the Bluetooth standard and most implementations of the IEEE 802.11 standard. Alternatively (or additionally), the personal area network communication module could be configured to transmit and receive in the ultra-wideband frequency range of 3.1-10.6 GHz.

Many examples of mobile devices, such as cellular telephones, that implement the Bluetooth standard are known. More specifically, some mobile devices employ Bluetooth communications to enable a wireless link between a cellular telephone and an ear-worn headset. In this implementation of the invention, the mobile device takes advantage of such existing short range wireless communications functionality (e.g., the Bluetooth link) to eliminate the need for additional hardware and expense. Alternatively, the personal area network communication module could implement any one or more of the IEEE 802.11 standards, commonly referred to as WiFi or “wireless fidelity.”

The personal area network communications module communicates over a bus with a processor and an application execution environment. The processor may be a digital signal processor, a conventional microprocessor, application specific integrated circuit, or the like.

The application execution environment (“AEE”) may be system memory in which resides and executes several computer-executable programs. Alternatively, the AEE could be implemented, perhaps partially, on an integrated circuits card, such as a SIM card or a USIM card. In one example, a phone program executes in the AEE to facilitate ordinary telephone operations of the mobile device. The user would execute the phone program, for instance, when making an ordinary telephone call using the cellular communication module.

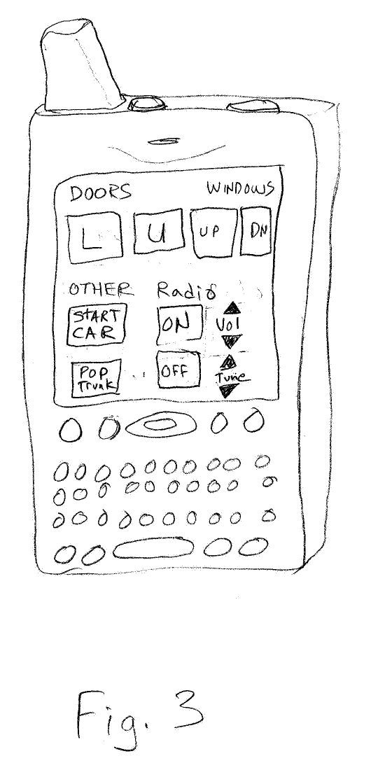

A remote access program executes in the AEE and is configured to present the user with options for transmitting remote access instructions. In one example, the remote access program is operative to present a user interface on a display, illustrated in FIG. 3 and described below, with various remote access options. Upon selection by the user, the remote access program transmits an instruction in accordance with the selection.

It is envisioned that the remote access program will transmit the instruction using the personal area network communication module. Alternatively, the remote access program could transmit the instruction using the cellular communications module using the conventional cellular telephone network down to a cellular receiver in the automobile. However, it is envisioned that transmitting the instruction using the personal area network communication module has the advantage that it avoids the dependency on adequate cellular coverage in the immediate vicinity. In other words, if a user is attempting to remotely unlock the doors of her car, she would prefer not to be dependent on whether there exists cellular coverage in the immediate area. The use of the personal area network communication module operates in a peer-to-peer fashion so that as long as the mobile device is within range of the automobile, the instruction can be transmitted.

The remote access program further includes configuration options that allow authentication or identification information to be embedded on the mobile device. In this way, perhaps at initiation or installation, the remote access program on the mobile device and the remote access controller on the automobile can be provisioned with authentication information to enable the mobile device to be uniquely paired with the remote access controller.

System files are computer-executable programs that perform system-level operations to enable the mobile device to function. The system files could additionally include any cryptographic keys or alternative mechanism used to authenticate the mobile device against a challenge issued by the remote access controller.

Other programs may also reside in and execute in the application execution environment, such as calendaring programs, e-mail programs, other productivity programs, or the like.

FIG. 3 is a graphical illustration of a sample mobile device in which embodiments of the invention may be implemented. As shown in figure three, the mobile device, includes a display and various input buttons. In this specific example, the mobile device includes special purpose input buttons and a miniature keypad.

The display, in this example, is a touch sensitive display as is in common use on certain cellular telephones, such as the Treo cellular telephone sold by the palmOne company. In this example, the remote access program has rendered on the display a user interface presenting the user with certain options. For example, the user may touch a button to cause an instruction to be issued to lock or unlock the doors of an automobile (or home), to roll up or down the windows of the automobile, to start the ignition of the automobile, to open the trunk, to turn the radio on or off, to adjust the volume, and to tune the radio. Again, although described here in the context of an automobile, alternative embodiments could be implemented in a home. These and several other options will become apparent to those skilled in the art.

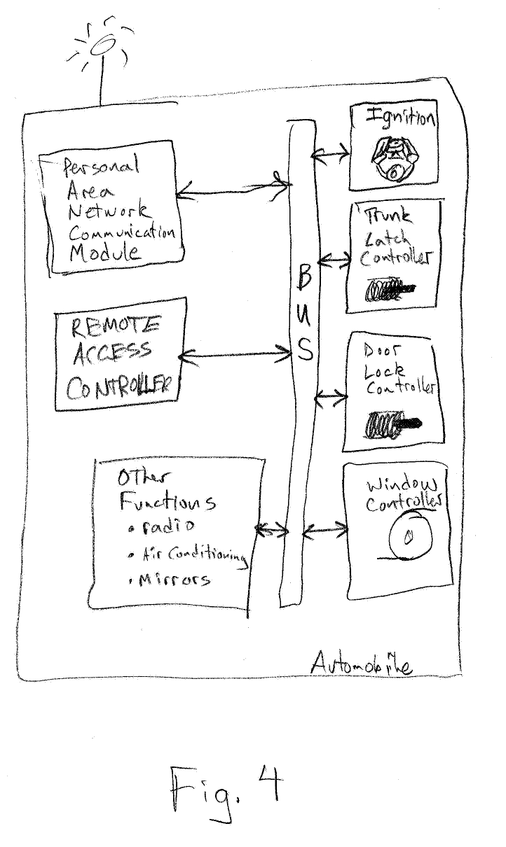

FIG. 4 is a functional block diagram generally illustrating in greater detail the automobile depicted in FIG. 1 and described above. As shown, the automobile includes several components that communicate over a bus. For example, a personal area network communication module is coupled to the bus and is configured to communicate with remote devices using a short range wireless communications infrastructure. In one specific implementation, the personal area network communication module is configured in accordance with the Bluetooth standard for personal area network of wireless communications. Automobiles that implement the Bluetooth standard for communications are currently known, albeit limited to facilitating telephone communications using a mobile phone coupled to the automobile through a Bluetooth link.

A remote access controller, also coupled to the bus, may be a software program or special purpose circuitry or mechanism for communicating with the personal area network communications module to receive a remote access instructions. Based on the particular remote access instruction received, the remote access controller may communicate, over the bus, with 81 or more issued particular actuators to carry out the remote access operations. For example, the remote access controller may be configured to instruct an ignition controller to start the car, a trunk let's controller to open the trunk, a door lock controller to block or unlock the doors, or a window controller to roll up or down the windows. Many other functions could also be coupled to the bus, and operate under the controller direction of the remote access controller. Examples of such other functions may include the radio, the air conditioning, electric mirrors, and the like.

Again, although described here in the context of an automobile, the remote access controller, the personal area network communications module, and any relevant remote access operation actuators could alternatively or additionally be implemented within a home.

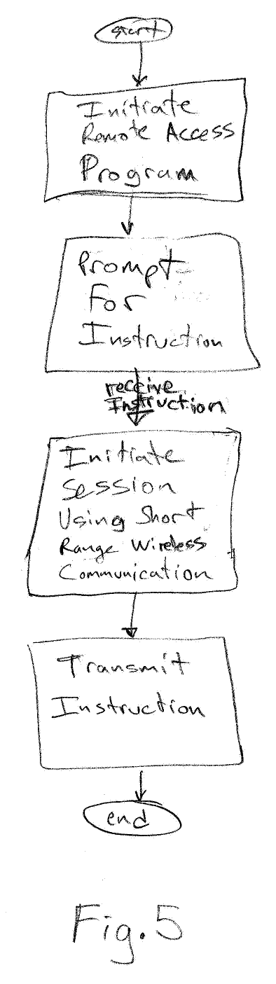

FIG. 5 is an operational flow diagram generally illustrating steps performed by a process for remotely activating access functionality of an automobile. The process begins with a mobile device on which resides a remote access program and a communications module operative to communicate over a short range wireless communications infrastructure.

At step 1, the remote access program is initiated. Initiating the remote access program may include activating an icon or other mechanism on the mobile device to cause the remote access program to execute in an application execution environment. The executing remote access program may prompt the user, at step 2, for particular instructions regarding remote access operations. For example, the user may be prompted with certain options that the user may select, such as door lock controls, window controls, and the like.

When an instruction is received, the process proceeds to step 3, where a session is initiated using a short range wireless communication functionality of the mobile device. Initiating the session may include establishing communications between the mobile device and a remote access controller in the automobile. Initiating the session may further include establishing secure communications between the mobile device and the remote access controller, such as perhaps using cryptographic keys or the like. In other words, cryptographic keys may be shared by the mobile device and the remote access controller.

In connection with initiating the session, the remote access controller could issue a key challenge to the mobile device to ensure that the mobile device is authorized to issue remote access instructions. Further authentication may be used to ensure that the user is authorized to perform these remote access operations, such as employing biometrics or the like.

At step 4, the mobile device transmits the instruction received. Transmitting the instruction is achieved using the short range wireless communications session just initiated at step three. The process then terminates.

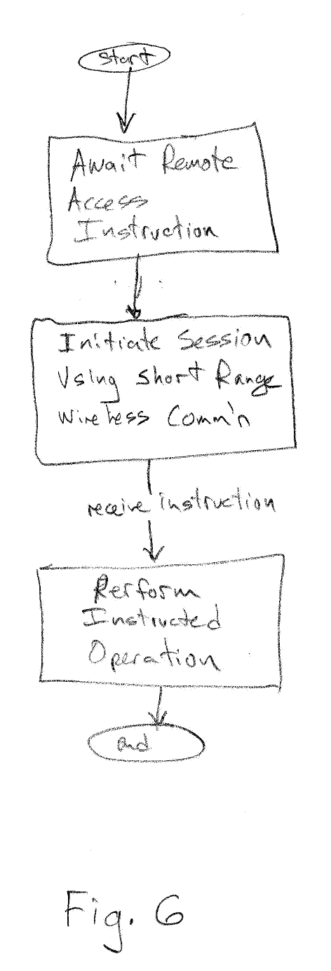

FIG. 6 is an operational flow diagram generally illustrating steps performed by a process for performing access operations under remote control. The process begins with an automobile that is configured with a remote access controller coupled to a short range wireless communications infrastructure. In this example, the short range wireless communications infrastructure may be configured in accordance with the Bluetooth standard.

At step 1, the automobile awaits a remote access instruction. At this step, a remote access controller may be listening for the initiation of a session or for the presence of a mobile device operating with the same short range wireless communications infrastructure as remote access controller.

At step 2, the mobile device operating with the same short range wireless communications infrastructure, and initiates a session with the mobile device using the short range wireless communications infrastructure. As with the process shown in FIG. 5, initiating the session may include establishing secure communications with the mobile device including any authentication or user identification. When an instruction is received from the mobile device over the short range wireless communications infrastructure, the process proceeds to step 3.

At step 3, the remote access controller causes to be performed the operation identified by the remote access instruction just received. In one example, the operation performed could include rolling up or down the windows, locking or unlocking the doors, ignition of the automobile, turning on or off the radio, adjusting the volume of the radio, tuning the radio to a different frequency, opening the trunk, adjusting the temperature of the air conditioning unit, and the like. The process then terminates.

The system just described enables users to incorporate into their cellular phones the remote access functionality previously requiring an additional, bulky key fob. Given that many individuals already carry a cellular phone, integrating the functionality of the key fob into the phone eliminates one additional remote device. In this way, the user could simply carry a single key in his pocket and avoid unsightly bulges.

Even though functionality far exceeding the simple locking and unlocking of doors may be implemented, the user is not being forced to more frequently replace batteries on a key fob. Users are already accustomed to frequently recharging their cellular phones, and thus no additional burden is created.

In one other alternative, the system described above could be implemented in an home rather than or in addition to the automobile. For instance, by including the remote access functionality described above for a wireless locking mechanism for the home, the user could lock and unlock his house without the need for a key, thus possibly eliminating the need for keys altogether.

Although the subject matter has been described with reference to specific implementations and embodiments, it is to be understood that the subject matter defined in the appended claims is not necessarily limited to the specific implementations and embodiments. Rather, the specific embodiments and implementations described above are disclosed as merely non-exhaustive examples of the inventions recited in the following claims.

We claim:

1. A remote control, comprising:
a mobile device configured with a personal area communications infrastructure and a wide area communications infrastructure, the wide area communications infrastructure being operative to facilitate voice communications between the mobile device and other devices, the personal area communications infrastructure being operative to communicate data between the mobile device and a remote access controller, the mobile device being further configured with a controller component operative to issue the data using the short range communications infrastructure, the data including an instruction to perform a remote access operation.

2. The remote control recited in claim 1, wherein the remote access operation comprises unlocking a door and/or a window.

3. The remote control recited in claim 1, wherein the remote access operation comprises opening a garage door.

4. The remote control recited in claim 1, wherein the personal area communications infrastructure operates with a center frequency substantially near 2.45 GHz.

5. The remote control recited in claim 1, wherein the personal area communications infrastructure operates with a center frequency selected from within a frequency range between substantially 3 GHz and substantially 11 GHz.

5. The remote control recited in claim 1, wherein the controller component is further configured to issue the instruction without manual intervention in response to the mobile device becoming proximate to the remote access controller.

6. A controlled device, comprising:
a remote access controller coupled to a short range communications infrastructure and operative to receive an instruction using the short range communications infrastructure, the remote access controller being configured to perform remote access operations including unlocking a door, the short range communications infrastructure being configured to operate with a center frequency substantially near 2.45 GHz.

7. A method for controlling access, comprising:
issuing an instruction to a remote access controller to perform a remote access operation, the instruction being issued from a mobile device using a personal area communications infrastructure, the mobile device further comprising a wide area communications infrastructure for facilitating voice communications between the mobile device and other devices, the remote access operation being operative to control a physical characteristic of a host system for the remote access controller.

8. The method recited in claim 7, wherein the physical characteristic of the host system comprises a locked state of a door.

9. The method recited in claim 7, wherein the physical characteristic of the host system comprises a closed state of a window.

10. The method recited in claim 7, wherein the host system comprises an automobile.

11. The method recited in claim 7, wherein the host system comprises a house.

12. The method recited in claim 7, further comprising issuing a second instruction to a second remote access controller, the second remote access controller having a second host system.

13. The method recited in claim 12, wherein the host system comprises an automobile and wherein the second host system comprises a house.

14. An integrated circuit card encoded with computer-executable instructions for performing the method recited in claim 7.
